(19) United States
(12) Patent Application Publication
(10) Pub. No.: US 2015/0196454 A1
(43) Pub. Date: Jul. 16, 2015

(54) Sexual Stimulation Devices and Methods

(71) Applicant: David Levy, Berkeley, CA (US)

(72) Inventor: David Levy, Berkeley, CA (US)

(21) Appl. No.: 14/153,073

(22) Filed: Jan. 12, 2014

(51) Int. Cl. A61H 19/00

(52) U.S. Cl. CPC A61H 19/32; A61H 2205/087; A61H 2201/123; A61H 2201/1692

(57) ABSTRACT

A sexual stimulation device includes a primarily cylindrical rigid housing containing a low durometer elastomeric material including an elongated cavity oriented along the primary axis of the housing and sized to receive a human penis and actuators disposed to provide pressure orthogonal to the interior surface of the cavity in a plurality of locations and under different control scenarios. Actuators include, magnetic, electromagnetic and cams.

### CROSS-REFERENCE TO RELATED APPLICATION

This application is a continuation-in-part of co-pending U.S. application Ser. No. 12/539,529 (Sexual Stimulation Devices and Methods) filed Aug. 11, 2009, which claims the benefit of the Aug.. 11, 2008 filing date of provisional application 61/087,821, (Sexual Stimulation Devices and Methods), the entire disclosures of both are incorporated herein by reference.

### TECHNICAL FIELD

This disclosure relates to devices and methods related to electrically operated artificial vaginas.

### BACKGROUND

The prior art is replete with sexual devices that provide a suction to a penis or vibration to a penis. Both provide sensations that are diffuse and distributed over the length of the shaft in a consistent and unchanging manner. Except for amplitude, the character of the output does not change. Existing vacuum devices, for example, apply a fairly consistent stimulus along the length of the penis and vibratory devices provide a stimulus that emanates from the specific location at which the vibrator motor is disposed. In both cases the amplitude of the sensation can be modified, however the stimulus remains in the same place with respect to the device and therefore provides a relatively unchanging stimulus. The device must be moved relative to the person to create a changing sensation. Furthermore the character and range of sensations provided by existing devices are limited, and moreover the degree of dynamic and interactive control that may be imposed by the user is also limited. The sensations provide “gross” sensations, rather than focused, customized, or sensations limited within a region. Other devices provides a sliding sensation, including traction along the shaft. This sensation is relatively uniform along the shaft.

It is therefore desirable to provide stimuli that can change during a usage, not just in amplitude or frequency but in character and/or shape. It is desirable to provide devices capable of providing stimuli that are varied, controllable, and subtle. It is further desirable to have the variable sensation independent of any thrusting motion. It is further desirable to have the variable sensation dependent on the thrusting motion in a variety of predictable and semi-predictable and non-predictable ways. It is also desirable to have the sensation dynamically variable, and yet still further, under dynamic control, whether the user is co-located, or distant. It is yet further desirable to have the same sensations provided at different locations within the device at different times. It is yet further desirable to couple the above benefits to a sensed level of arousal. It is further desirable to provide an artificial vagina that provides a contractile output. It is yet further desirable to provide the stimulus of an undulating contractile output. It is also desirable to allow a device to provide a localized output sensation at a different location at which the control is input. It is further desirable to provide this functionality concurrent with and integral to the action of grasping the device.

### SUMMARY

One aspect of the invention features a sexual stimulation device with a housing, a low durometer elastomeric sleeve including a cavity dimensioned to receive a human penis and a variety of mechanisms to displace the outer surface of the cavity inwards.

In some embodiments magnets are permanently disposed about the circumference of the cavity, either molded within the material itself or adhered to the outside of the material. In the first case, a method is disclosed for molding magnets within the sleeve that leave a residual identifying feature.

In some embodiments the permanently disposed magnets are displaced by second category of magnet. The orientation of the two sets of magnets are such that pairs of magnets repel one another when associated. In one such embodiment the second set of magnets are disposed along a linear slide actuated by an electromechanical actuator, which may be a solenoid. The slide is oriented along the primary axis of the cavity. In one such embodiment the plurality of second magnets are spaced similarly to the first plurality with which they are associated thereby enabling a simultaneous effect and in a closely related embodiment the plurality of second magnets are spaced dissimilarly to the first plurality with which they are associated thereby enabling a wavelike (if the spacing is consistently offset) or random effect (if the spacing is random).

In the preferred embodiments the predominant mode of stimulation is provided by a local region of the cavity displacing orthogonally, thereby applying a localized pressure to the penis. In some embodiments this pressure may be provided in only one localized region at a time. In other embodiments the localized pressure areas are activated simultaneously, in other embodiments the localized pressure areas are activated in asynchrony, thereby capable of providing a wavelike sensation. These functions are provided by a control system and under control of the user through a user interface which may be local or at a distance over the telephone or Internet.

In one embodiment the housing includes a rotary portion that captures one end of the low durometer sleeve such that turning the rotary portion serves to reduce the cross-sectional area of the cavity along the length of the sleeve. This may include a detent feature thereby maintaining a specific cross-sectional area and therefore a desired constant pressure along the surface of the penis.

In some embodiments the device includes a magnet disposed proximate a plurality of defined pressure regions. In some embodiments a second magnet is disposed to be intermittently in contact with the permanently located magnets. In some embodiments a solenoid in the housing is associated with the magnets disposed in the sleeve. In some embodiments a cam system is used to displace local regions. In some embodiments a solenoid is used to displace a magnet which in turn displaces and associated magnet disposed within the sleeve.

In some embodiments a method is disclosed for providing sexual pleasure including the steps of providing a low durometer elastomeric sleeve dimensioned to accommodate a human penis, inserting the penis into the sleeve and applying forces to a plurality of localized surface regions of the sleeve in an orientation orthogonal to the sleeve surface at each of the plurality. This method can be used to provide a wavelike sensation, individual pressure points, a random series of actuations or simultaneous actuations at a plurality of locations.

### BRIEF DESCRIPTION OF DRAWINGS

FIG. 1 is an axial sectional view of a male stimulation device with rotation-enabled constrictive sense variation.

FIG. 2 is an isometric view of an internal rotary shaft for a sexual pleasure device.

FIG. 3 is an end-wise cross sectional view of a device with multiple shafts as shown in FIG. 2.

FIG. 4 is an axial isometric view of a rotary shaft for sexual stimulation incorporating magnets.

FIG. 5 is an axial sectional view of a sexual stimulation device incorporating magnets and electrically driven magnetic fields.

FIG. 6 is an axial sectional view of a sexual stimulation device incorporating solenoids.

FIG. 7a is a view of the tooling for producing encapsulated magnets.

FIG. 7b is a view of the product produced by the tooling of FIG. 7.

FIG. 7c a view of an alternate embodiment product produced by the tooling of FIG. 7a.

FIG. 8 shows the shaft of FIG. 4 with magnets disposed on contact points.

FIG. 9 shows a male sexual stimulation device activated by solenoids driving a first magnet into a second magnet embedded in an elastomer.

FIG. 10-12 are related. FIG. 10 shows a plurality of magnets on a shaft activated by solenoids.

FIG. 11 shows the shaft of FIG. 10 disposed within a device in an activated state.

FIG. 12 shows the device of FIG. 11 in a non-activated state.

Like reference symbols in the various drawings indicate like elements.

### DETAILED DESCRIPTION

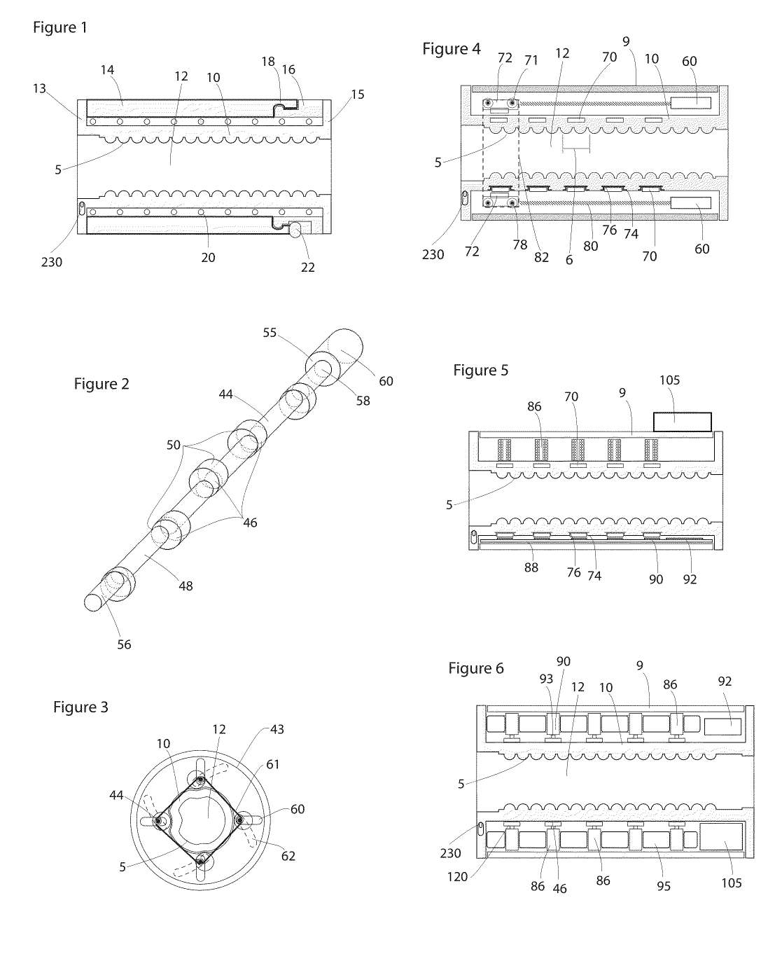

FIG. 1 shows an embodiment in which sleeve 10 manufactured of low durometer elastomeric material, such as styrene-ethylene propylene-styrene block copolymer (SEPS) or any material that approximates human flesh and molded to include cavity 12 designed to accommodate a human penis. It is known in the art that a suitable elastomeric gel may be formed from a mixture of plasticizing oil and a block copolymer comprising an admixture of a styrene ethylene butylene styrene block copolymer and a styrene ethylene propylene styrene block copolymer. A ratio of about 1:1 is desirable, but the two may be combined in ratios in the range from about 1:4 to 4:1. The contact surface 5 of cavity 12 may be smooth or have a texture as shown. A first end 13 of sleeve 10 is constrained by a first housing element 14. A second end 15 of sleeve 10 is constrained by a second housing element 16. Housing element 14 and second housing element 16 are rotatably engaged by rotary element 18. Rotation of housing elements 14 and 16 cause torsion on sleeve 10, thereby reducing the cross section of sleeve 10 and increasing pressure applied to a penis inserted therein. Stored bulk torsional forces within sleeve 10 also provide a rotational force to return second housing element 16 to a neutral state, a force that may be augmented by spring element 20. Locking mechanism 22 may be used to maintain the position of the device (by opposing the return force(s) in varying rotational orientations and thereby a varying degrees of applied pressure. In a first mode a user may use the locking feature to permanently customize the device to provide a desired level of pressure during use. In a second mode a user may rotate the housings 14 and 16 and thereby vary the sensations dynamically during use.

General note: It is here understood that approximating the human body parts as idealized cylinders is an engineering approximation. The cavity 12 may be tapered, or have molded undulations, or irregularities and the like, and be well within the scope of this invention. In all cases, the topic at hand is the stimulation being applied to the human body, (i.e. relative changes in force and/or pressure) not the specific geometry of the contour of surface 5.

FIG. 2 shows an embodiment in which rotary element 44 including at least one pressure element 46 are disposed intermittently along shaft 48, including first end 56 and second end 58. Pressure elements 46 are here shown as cylindrical elements offset with respect to shaft 48 in different directions, similar to the cam shaft of an internal combustion engine. Pressure elements 46 are disposed with pressure surfaces 50 located distal to shaft 48. Rotary elements 44 are driven by one or more motors 60 through any of a variety of known transmission means, the simplest of which is to place a rotary motor at one end of each rotary element 44. Shaft 48 may be made of a flexible material, such as a coil spring or elastomeric equivalent if rotary element 44 used in a phallic-type device.

FIG. 3 shows an embodiment in which a plurality of rotary elements 44 are disposed along an approximately circular path around the circumference of sleeve 10. Low friction surface 43 is disposed around sleeve 10 and allows rotation of pressure elements 44 against sleeve 10 without causing undue abrasion. Low friction surface 43 may be provided by a thin Teflon sheet, or a lubricant either applied to the surface of the sleeve or incorporated in to the material of sleeve 10 itself. Referring now to FIGS. 3 and 4, a variety of sensations may be provided to a user at contact surface 5: In a first mode, rotary elements 44 are oriented such that the pressure elements 46 (and pressure surfaces 50) disposed in a common plane apply pressure to sleeve 10 at the same time. Therefore, as rotary elements 44 rotate in unison (through an encoder 55 or common transmission 61), a wave of constriction moves along the length of sleeve 10. In a second mode all rotary elements 44 are oriented in the same direction as each other, such that only one pressure surface 50 applies maximal pressure to sleeve 10 at a time, within a given plane. Therefore as rotary elements 44 rotate, a plurality of pressure waves traverse the length of sleeve 10 out of phase with each other, one wave for each rotary element 44. In a third mode rotary elements 44 are randomly oriented and or rotated with respect to one another, thereby producing random undulations along the perimeter of sleeve 10. In a fourth mode rotary elements 44 are driven alternately clockwise and anti clockwise, thereby providing a localized and varying pressure at any location along the length of sleeve 10. This location may be modified by rotating each of rotary elements 44 such that a different set of pressure elements 46 (within a plane) are nominally oriented toward sleeve 10. Pressure elements 46 may be nautilus shaped.

The position of first end 56 and second end 58 can vary radially to accommodate a variety of phallus diameters and/or to provide a varying degree of sensation according to the user's preference. In one embodiment first end 56 is constrained by both a radial channel 60 and slot 62. Slot 62 is a slanted or curved opening in disk 64 that constrains first end 56 to a defined radial displacement as a function of its rotation.

FIG. 4 shows an embodiment in which magnets 70, disposed on or near the outer surface of sleeve 10, are used to apply pressure along contact surface 5 to a penis located within sleeve 10, within housing 9. The finite and well-defined area of each magnet 70 creates a defined contact area which is then translated through contact surface 5 to provide a sensation in the user. By using a defined pressure source (such as magnet 70 or the contact surface of pressure element 46) contact surface 5 provides a defined contact surface 6. Defined contact surface 6 provide a different sensation than a non-defined extensive area of contact. This is desirable in some embodiments. If the area is too small, the pressure is too high and uncomfortable. If the area is too large the pressure is too small and does not provide the desired stimulation. As a reference to dynamic tactile perception, massage can be used as a simple analogy. An elbow applied to the back might be too much intensity (for some users) and pressure applied to the entire back is unsatisfying (to most users.) The optimal sensation is provided by a focused contact point with an appropriate level of pressure such as provided by the palm of the hand. With respect to a human sexual organ the desired contact surface area is approximately 0.05 square inches (e.g. a circular area of ¼″ diameter) to 1.2 square inches (e.g. A circular area of 0.62″ diameter.) It is also noted that the specific material disposed between the pressure source (e.g magnet 70, pressure element 46, etc) and the skin and the thickness of the material disposed there between, will prescribe how much larger the defined contact surface 6 will be over the pressure source.

Magnets 70 may be co-molded within sleeve 10, as shown in the upper half of the figure, or adhered, as shown in the lower half of the figure. If adhered, it is desirable to use a carrier interface 74, preferably molded from a plastic, to both distribute the force of the magnet and to allow an intermediate bonding surface, i.e. magnet to plastic and plastic to sleeve 10. Carrier interface 74 also includes flange 76 to provide mechanical bonding. In one embodiment sensations are provided to a user by at least one drive magnet 72 brought into proximity to each fixed magnet 70 sequentially. Controls may be implemented with simple discrete electronics to drive in this embodiment a shuttle 78 is driven axially (as shown) by threaded shaft 80 driven by motor 60. Shuttle 78 may have sliding engagement with housing 9, or wheels 71. Other drive mechanisms, such a belt drive are within the scope of the invention. In one embodiment ring 82 holds a plurality of drive magnets 72 disposed around the circumference of sleeve 10 such that a single motor can displace the shuttle and provide a constricting sensation in a plurality of distinct locations simultaneously. (In such embodiments one of the motors 60 shown in the figure would be omitted.) another embodiment magnets 70 are replaced by a pressure element 46 is fashioned from a rolling element and located on shuttle 78. As is the case with other embodiments herein that include electronic operation, this embodiment may be operated remotely by phone or by the internet. If molded with the material, the preferred location for each magnet is to be disposed proximate to the outer surface (ie most distal to the primary axis of the cavity 12.

FIG. 5 shows an embodiment that uses the sleeve 10 and magnet 70 assembly described in FIG. 4, but provides actuation by means of a series of conductive coils 90 and/or solenoids 86, as shown on the upper half of the figure, or printed within a printed circuit board 88, as shown on the lower half of the figure. Coils 90 are in electrical communication with a control system 92 and a power source 105 such that one or more magnets 70 may be displaced individually or in sets to provide a wide variety of sensory outputs to a penis located within sleeve 10. A partial list of the variety is provided in FIG. 2, however this embodiment may also actuate individual (i.e. specific) locations, as opposed to rings or lines, or relatively large areas, and may provide differing frequencies of stimulation at each coil 90. For example, while all actuators provide a constant force (i.e. pure contracture) rhythmically altering force, or a force altering in sequence of waves along sleeve 10, one or more coils 90 may provide a low or high frequency localized vibration, which may remain in one location, or may be superimposed onto the aforementioned output. The system may provide random (or pseudo-random) output, thereby massaging/ tingling sensation to the body part over a range of frequencies, from very low (e.g. zero) to very high (e.g. 1000 Hertz). Including a sensor 230 (such as infrared or capacitive) to measure the presence and/or displacement of the penis within the device.

FIG. 6 shows embodiment with similar functionality described in FIG. 5. In this embodiment, the force is applied to sleeve 10 by a mechanical displacement of a post 93 within coil 90, together forming solenoid 86. Solenoids 86 are restrained to an approximately orthogonal orientation by form 95 and capped by pressure elements 46. Alternately solenoids 86 may be capped by weights 120. In one embodiment, ones of solenoids 86 may be disposed at an angle, thereby providing a stretching in sleeve 10, thereby enhanced friction and sensation on the user.

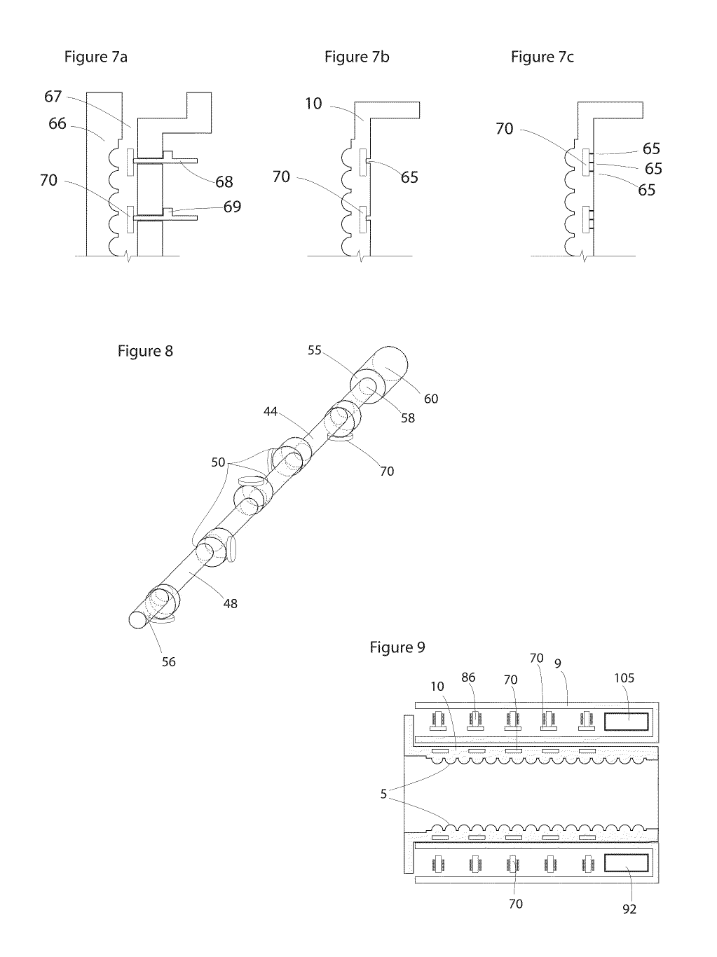

FIG. 7a shows tooling 66 for embedding magnets within sleeve 10. Cavity 67 defines the shape of the sleeves 10. As a step of the molding process, supports 68 are inserted into holes in the side of tooling 66.

The position of support 68 are accurately and repeatably provided by hard stops 69. After being positioned, magnets 70 are placed on the ends of supports 68 accurately positioning them within the cavity 67. After sleeve 10 has solidified, supports 68 are removed. FIG. 7b shows sleeve 10 with magnets 70 and residual support indentations 65, indicating that the method was used during manufacture. FIG. 7c shows an embodiment in which three residual support indentations are associated with each magnet 70.

FIG. 8 shows an embodiment of shaft 48 in which the pressure plates 46 are implemented with magnets 70. In such embodiments magnets 70 provide an assay distance force when matched with a paired magnet 70 in which common poless (e.g south and south) are oriented facing each other so that the magnets are repelling each other.

FIG. 9 shows an embodiment in which magnets 70 are disposed along sleeve 10 and each actuated by an associated magnet 70 and solenoid 86 combination. Utilizing individual solenoids along the sleeve 10 offers a wide variety of sensations to be provided by control electronics 92, including wave patterns randomness, uniform construction, at a variety of frequencies, as low as a few Hertz and as high as hundreds of Hertz. Each pair of magnets 70 is oriented to repel one another, as in a “North to North” orientation. Two embodiments are represented in the figure. The upper half shows an inverted T shape structure in which a magnet 70 is disposed on the armature of a linear solenoid 86, the armature representing the vertical portion of the “T”. The lower half shows an embodiment in which a magnet 70 is also disposed within solenoid 86. In this embodiment the magnets 70 within the sleeve 10 are relatively flat and wide while the magnet 70 within solenoid 86 is relatively long and thin. Specific geometries will be optimized for each product. By orthogonally displacing defined contact surface 6 utilizing with an at-a-distance magnetic force allows sleeves 10 to be removed from housing 9 for cleaning and interchangeability moment training a smooth interface and protecting the electo-mechanics of the device from incidental contact and damage. Both embodiments are powered by power source 105.

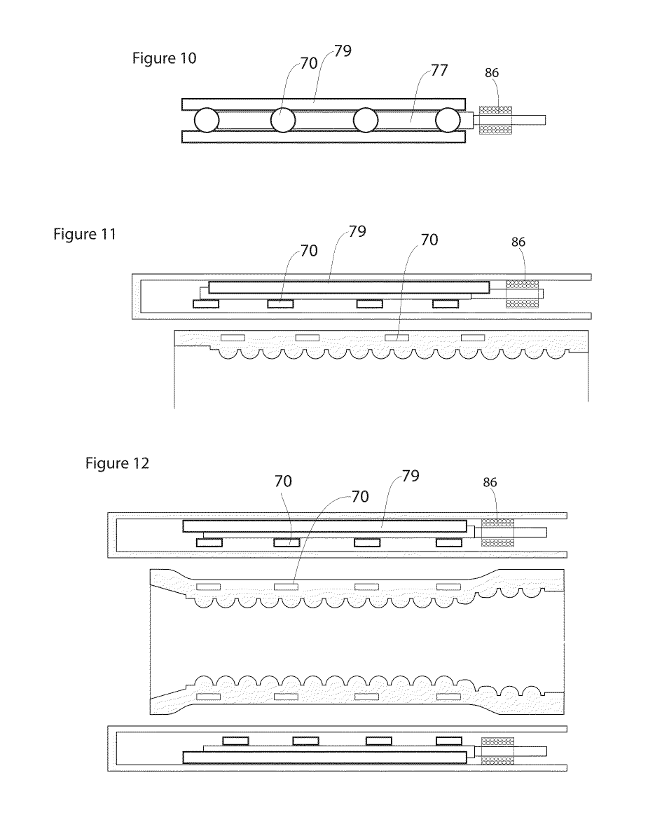

FIG. 10 shows a top view of a mechanism in which a plurality of magnets 70 are disposed on a movable carrier 77 restrained by a bearing slide 79. This embodiment is linear, although one skilled in the art can see how it could be implemented in a rotary fashion. Carrier 77 is displaced by solenoid 86 to displaced along slide 79 by an electro-mechanical actuator such as solenoid 86.

FIG. 11 shows a side view of the mechanism of FIG. 10 disposed within housing 9. Solenoid 86 is not activated and associated pairs of magnets 70 are (intentionally) poorly aligned and therefore have minimal opposition force between them. As a result sleeve 10 is in its rest position. When solenoid 86 is activated associated pairs of magnets 70 are well aligned and therefore sleeve 10 is displaced inwardly and applies approximately orthogonal force to the penis within its circumference. Furthermore, by offsetting the location of magnets 70, either on carrier 77 or within sleeve 10 (as shown in the lower half of FIG. 12) control system 92 may provide a wavelike effect as the location of the force will appear to move from one end of the device to the other, as each pairing of magnets 70 comes into direct opposition a different moment in time.

One embodiment includes a plurality of such mechanisms (e.g. FIG. 3) disposed around the circumference of the device. Such an embodiment may include different layouts of magnets 70. In a preferred embodiment control system 92 may independently control the plurality of solenoids thereby enabling extremely wide range of sensations. One advantage of the solenoid-driven embodiments over motorized versions operating at higher frequency is relatively quiet operation. In one embodiment magnets 70 may be slightly tilted and still provide primarily orthogonal pressure to the penis.

The details of one or more embodiments of the invention are set forth in the accompanying drawings and descriptions. While several embodiments have been described, it will be apparent to one skilled in the art how the form, structure and arrangement of these embodiments may be varied (or combined with each other) and yet remain within the scope of the instant invention. The scope of the invention shall therefore be defined by the claims that follow.

What is claimed:

1. A sexual stimulation device wherein the predominant mode of stimulation is provided by at least one actuator disposed to translate at least one defined pressure region of said sexual stimulation device in an axis approximately orthogonal to a portion of a sexual organ in contact with the pressure region.

2. The device of claim 1 further including a prominently cylindrical volume of low durometer elastomeric material including a cavity designed to accommodate a human penis wherein the pressure region is disposed on an inner surface of the cavity.

3. The device of claim 2 further including at least a first magnet disposed proximate to each one of the defined pressure regions.

4. The device of claim 3 further including at least one second magnet disposed to be intermittently in contact with ones of the first magnets and oriented such that said first and second magnets repel each other, thereby displacing at least a portion of an internal wall of the cavity inwards.

5. The device of claim 1 further including plurality of distinct pressure regions.

6. The device of claim 4 wherein the at least one second magnet translates axially along the major axis of the cylinder.

7. The device of claim 4 further including a plurality of second magnets spaced along the length of a sliding mechanism in which the sliding mechanism is displaced linearly by an electromechanical actuator and further including a control system.

8. The device of claim 7 wherein the associated first and second magnets are spaced similar to each other.

9. The device of claim 7 wherein the associated first and second magnets are spaced dissimilar to each other.

10. The device of claim 3 further including a solenoid associated with at least one of the first magnets.

11. The device of claim 2 wherein the pressure region is displaced by a magnet.

12. The device of claim 2 wherein the pressure region is displaced by a cam.

13. A sexual stimulation device including a volume of low durometer elastomeric material including a predominantly cylindrical cavity designed to accommodate a human penis including a plurality of first magnets disposed distal to and about the circumference of the cavity.

14. The device of claim 13 further including a rigid housing and at least one electro mechanical actuator disposed to displace the plurality of first magnets.

15. The device of claim 14 wherein the actuator is at least one solenoid

16. The device of claim 15 wherein the solenoid is disposed to translate a second magnet oriented to repel at least one of the first plurality.

17. The device of claim 13 further including evidence of at least one small hole molded into the material from the ambient air to the surface of one's of the plurality of first magnets.

18. A method for proving sexual pleasure including the steps of providing a low durometer elastomeric sleeve dimensioned to accommodate a human penis, inserting the penis into the sleeve, applying forces to a plurality of localized surface regions of the sleeve in an orientation orthogonal to the sleeve surface at each of the plurality, thereby providing novel sensations to the penis.

19. The method of claim 18 further including applying forces to selected regions of the sleeve sequentially in a planar or wave-like manner, starting at a first end of the sleeve and progressing to a second end, said selected regions disposed approximately about a plane as is translates parallel along a primary axis of the sleeve.

20. The method of claim 18 further including applying forces to individual surface regions randomly.
